(19) United States
(12) Patent Application Publication
(10) Pub. No.: US 2005/0177434 A1
(43) Pub. Date: Aug. 11, 2005

(54) Method for marketing and organization of creative content over an online medium

(76) Inventor: Loren E. Davie, Montclair, NJ (US)

Correspondence Address: Loren Davie, 8 Emerson Pl., Montclair, NJ, 07043, US

(21) Appl. No.: 11/052,565

(22) Filed: Feb. 7, 2005

Related U.S. Application Data
(60) Provisional application No. 60/542,450, filed on Feb. 6, 2004.

(51) Int. Cl. G06F 17/60

(52) U.S. Cl. 705/16; 705/26

(57) ABSTRACT

A system for organizing and marketing creative content over an online medium. The system organizes content into “content cards”: electronic representations of collectable cards. Cards are distributed through a configurable distribution system which takes factors such as the user's personal preferences and the aggregate popularity of cards into account. The cards are sent over a network such as the Internet and are rendered for the user. A content card allows a user to sample content and purchase related products directly from the card. The system has an extensive provision for interpreting user reactions to content and modifying the popularity of content cards, both as they relate to a specific user, and in their overall popularity.

### CROSS-REFERENCE TO RELATED APPLICATIONS

This application claims the benefit of provisional patent application Ser. No. 60/542,450 “Method for marketing and organization of creative content in an online medium”, filed Feb. 6, 2004 by the present inventor.

### FEDERALLY SPONOSRED RESEARCH

Not applicable

### SEQUENCE LISTING OR PROGRAM

Not applicable

### BACKGROUND OF THE INVENTION—FIELD OF THE INVENTION

This invention generally relates to the marketing and distribution of creative content, such as (but not limited to) music, movies, written works, video games, visual art and so forth, and specifically to an improved method for marketing and organizing such content for the benefit of prospective consumers and other interested parties, over an online medium such as the Internet.

### BACKGROUND OF THE INVENTION—PRIOR ART

Before the popular adoption of the Internet, creative content had to be packaged, marketed and sold in physical media such as compact disks (CDs), paper books and Digital Versatile Disks (DVDs). Because creative content was embodied in physical media, it was necessary for the creators and distributors of such works to incur the cost and effort of shipping and warehousing. Additionally, the use of physical media raised issues of manufacturing, such as gauging the demand for a work and then manufacturing units to meet that demand. If the creators and distributors of the work misestimated the demand for a work, they were left with an expensive overrun or be unable to meet demand due to an under-run.

With the popularization of the Internet, it became feasible to distribute creative content as digitized electronic files over the network, delivering them directly to a consumer's computer. Electronic distribution was free of the costs of physical shipping, warehousing and the risks of misestimating demand for a work.

What electronic distribution did not bring was a reliable mechanism to allow consumers to find creative content that suited their individual tastes, to organize the content and to receive periodic updates regarding the content. Search engines allowed for location of content, but the consumer had to know what they were looking for: search terms for a specific creator or genre had to be entered. These terms were usually too broad (in the case of genres) or too specific (in the case of individual creators) to maximize the consumer's ability to locate new content. Retail websites that specialized in the sale of creative content were constructed on a “store” metaphor. They offered categorized content, but did not provide tools for the user to allow them to find new content through its relevance to content that they had previously indicated they preferred, nor did they organize content that they had already been acquired by the consumer.

Some of the most sophisticated e-commerce websites, such as Amazon.com, provided “personalization” functionality in which a user's purchases were tracked in order to create a “profile” that was then used to provide suggestions to the user as to content that might suit them. While this was an improvement, it had several limitations. First, there was no mechanism for a user to indicate a preference for the creative content besides actually purchasing it. Secondly there was no way for a consumer to indicate active dislike of content, and lastly the “unit of consideration” when determining the popularity or appropriateness of creative content was innately bound to the bundling in which it was sold. In other words, if music was sold in CD format, the user could only express a preference for the entire CD or not, and not indicate their preference for an individual song on that CD.

Therefore, the current state of electronic distribution of creative content is one of “information overload”. Consumers are not able to to easily locate content that suits their individual tastes without a large investment of time spent searching for it. There exists an effective “chasm” between the creators of creative content, who seek to find an audience that will appreciate their work, and consumers, who seek content that meets their individual tastes.

### BACKGROUND OF THE INVENTION—OBJECTS AND ADVANTAGES

Accordingly, several objects and advantages of my invention are as follows:

To provide a means for creative content to be distributed and marketed without incurring the costs and logistical overhead of physical media, such as shipping, manufacturing and warehousing costs. To allow the creator of the creative content to offer a supply of content that exactly matches its demand, eliminating costly overruns or inconvenient under-runs.

To provide a means to allow users to easily locate content that they like. To allow users to not have to know what they are looking for explicitly, but instead to interpret the user's tastes and provide content that seems likely to match. As the user “becomes known”, they will receive increasingly more accurate suggestions of creative content, thus increasing the chances that the user will enjoy what is being suggested.

To make the invention easy for the consumer to use, providing a straightforward and consistent user interface. Once learned the user interface should become effectively “transparent” to the user, meaning that it functions quietly without distracting the user from finding content, which is their objective.

To make the “searchable unit of consideration”, meaning the electronic item that is found as the result of the system's suggestion, an arbitrary unit of organization. The searchable unit can represent the creator of the work, a thematic collection of works, a particular anthology or personal collection, a particular body of work and so forth. It should be independent of the bundle in which the content is sold. For example a particular movie actor could be presented as a “unit of consideration” with DVDs in which the actor played offered for sale. Purchasing the DVD would not necessarily indicate a preference for other actors in the DVD, some of which might be disliked by the user.

To allow any number of user actions to be indications of a preference or dislike for content. To allow the user to express preferences at different levels of strength, and to additionally express negative reactions to content, which should be used to filter out content that they dislike. Unlike prior art, the invention should interpret more than just the purchase of content as an indicator of a preference towards or against specific content.

### SUMMARY

The invention provides a representation of a card (similar to a playing card) that is rendered through a display. In one embodiment of the invention, the card would be rendered as a web page that is viewed through a web browser program such as Microsoft Internet Explorer or Netscape Communicator. The card shows a representation of a bundle of content, arranged by some sort of logical grouping (such as creator, theme, venue etc.). The rendered representation of the card will provide some background information on its subject, as well as provide samples of content that the user may try free of charge. The user may then buy content directly from the card, if they wish.

The invention tracks popularity of cards in response to user actions. The purchase of content is considered a strong positive indicator, whereas the user taking action to “filter” the card out in the future is considered a strong negative action. By interpreting user action, the invention will record both the personal preferences of the user, as well as the aggregate popularity of the card.

The cards may be distributed to users over a variety of media, depending on the embodiment of the invention, including but not limited to: HTML representations of cards as the result of a search from a web page, cards sent to a user via their email, cards displayed on cell phones and so on.

### DRAWINGS—FIGURES

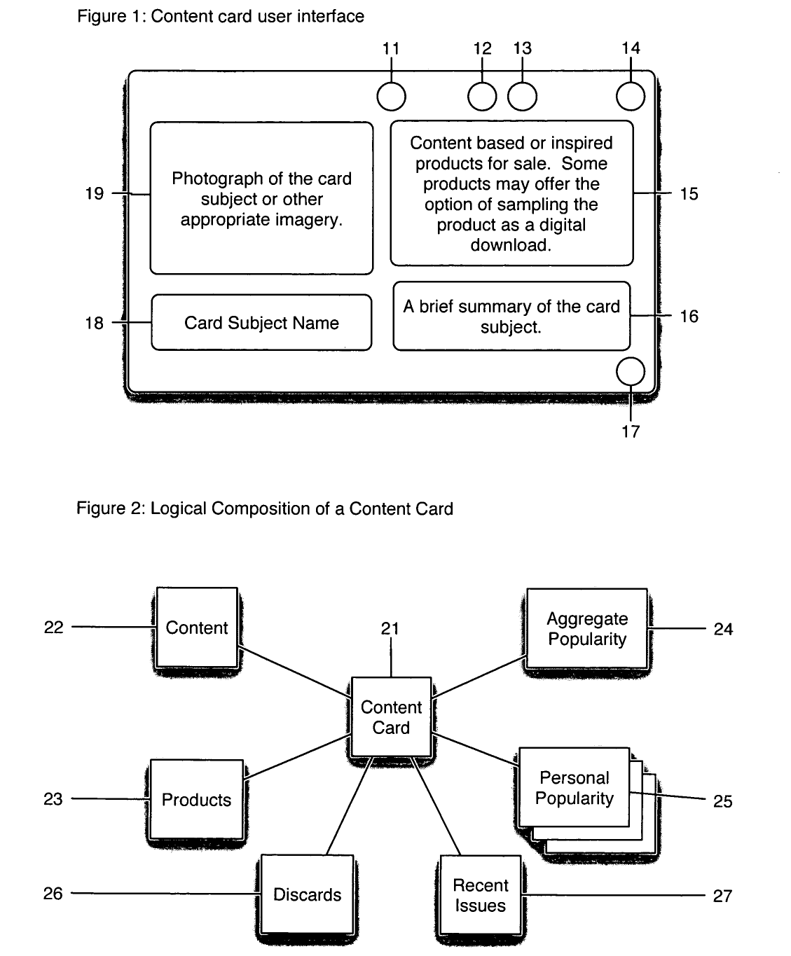

Diagram 1: FIG. 1 is a layout view of the user interface for a content card, representing a searchable unit of consideration in the invention. It shows the topical controls available to the user. FIG. 2 shows the logical composition of a content card: the data that is associated with a single content card.

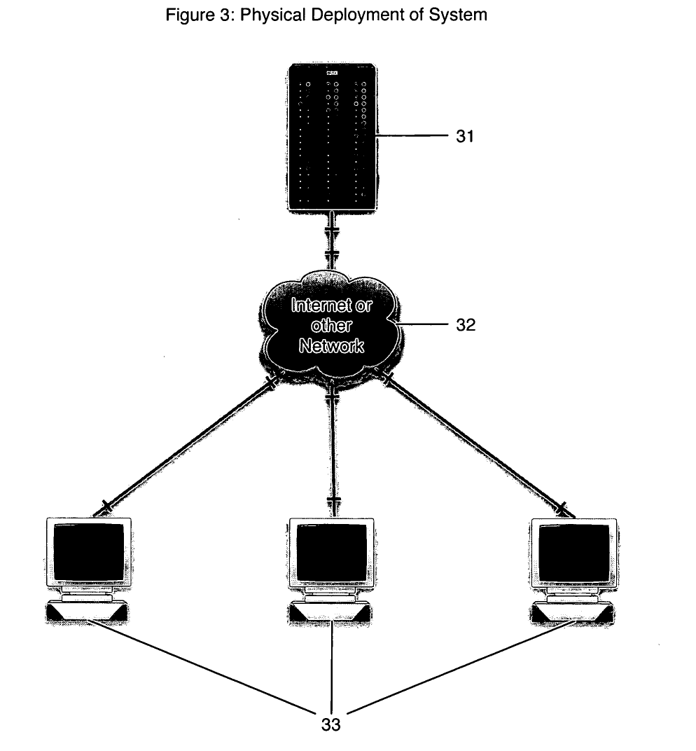

Diagram 2: FIG. 3 is a deployment diagram representing the physical deployment of the invention, in one embodiment.

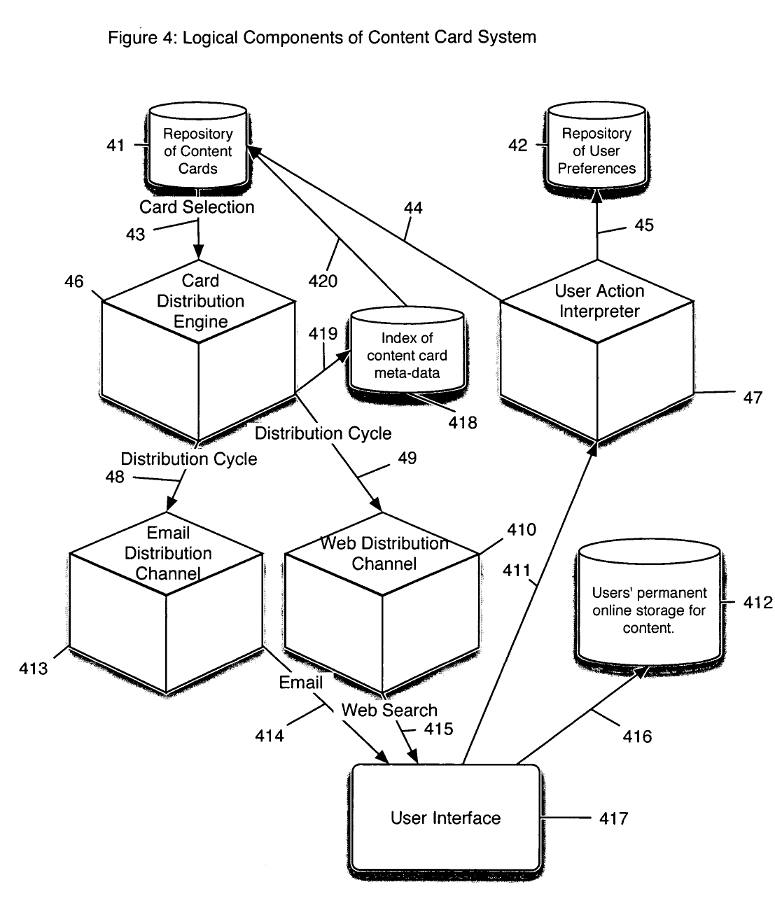

Diagram 3: FIG. 4 is a logical view of the major systems and their associations within the invention. It details the major subsystems that operate the invention.

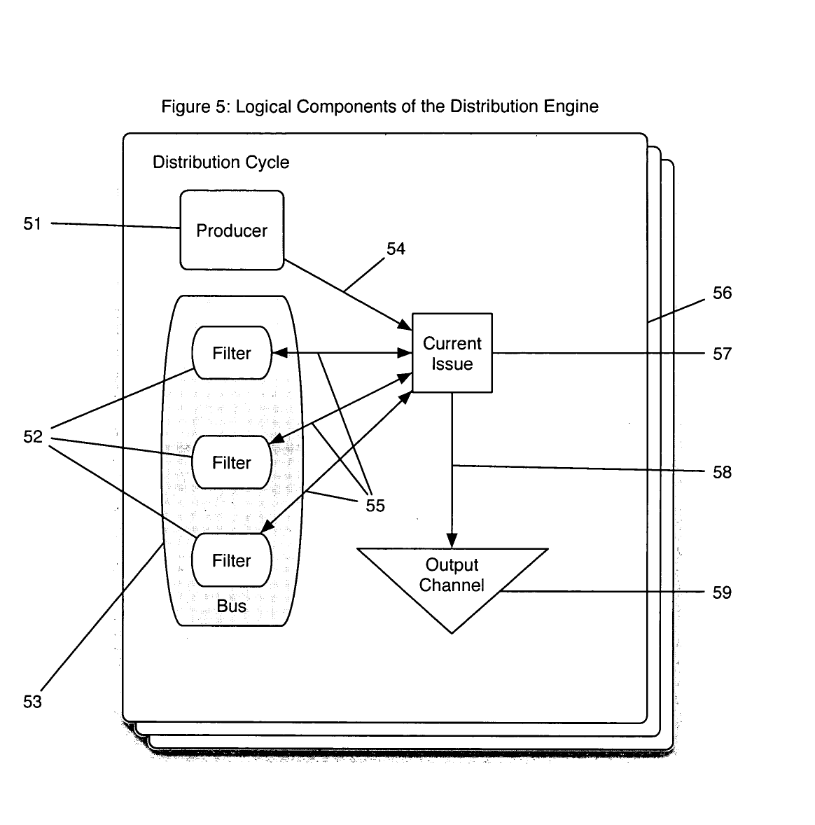

Diagram 4: FIG. 5 is a logical view of the distribution engine. It details the logical parts that operate on content card distribution.

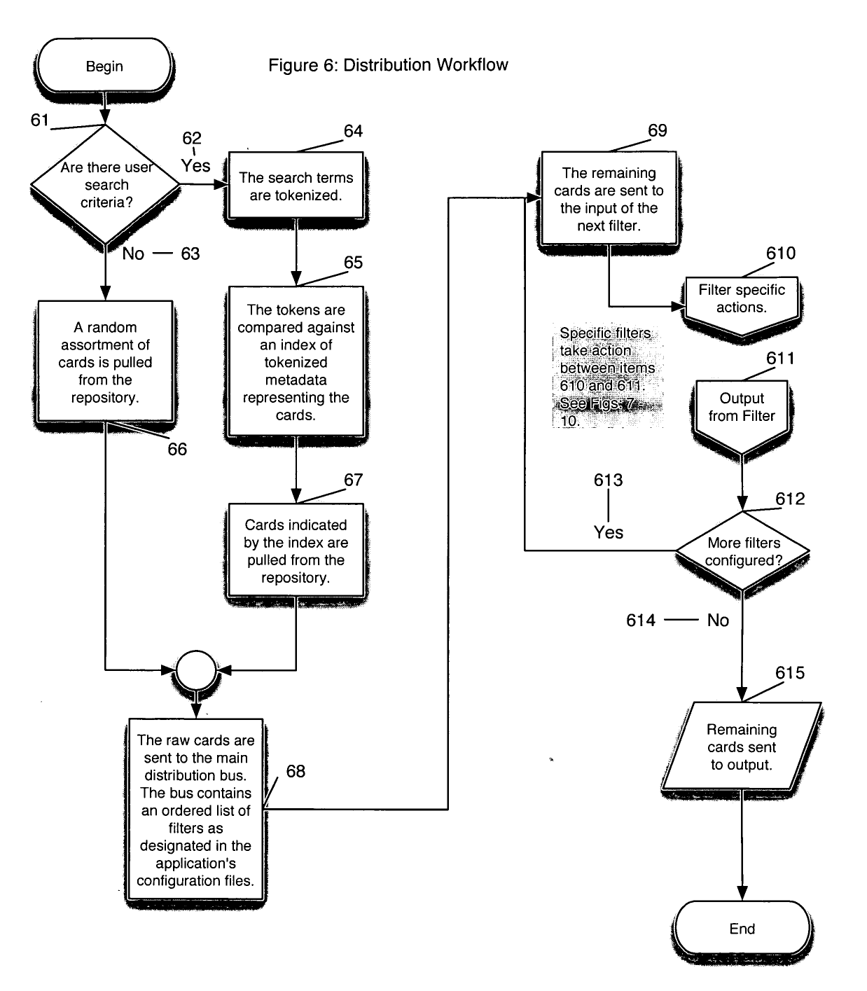

Diagram 5: FIG. 6 is a flowchart showing the distribution system loading a collection of content cards according to various criteria, to be sent to an output channel such as a web search result page or an automated email.

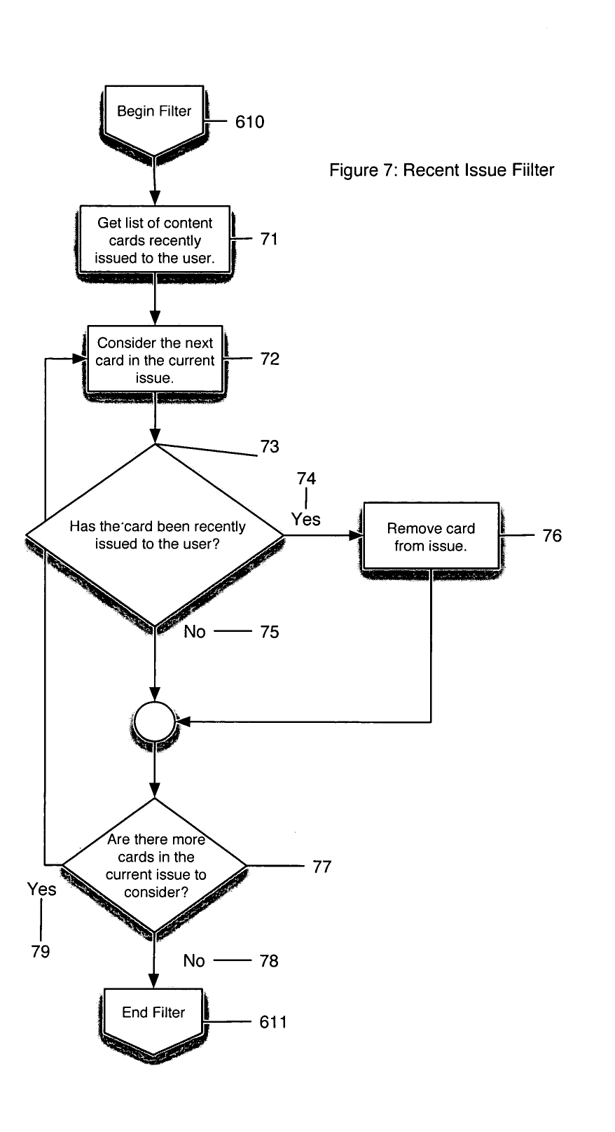

Diagram 6: FIG. 7 is a flowchart showing the operation of a recent issue filter, one of several “content filters” that may be used by the distribution system whose operation is detailed in FIG. 6.

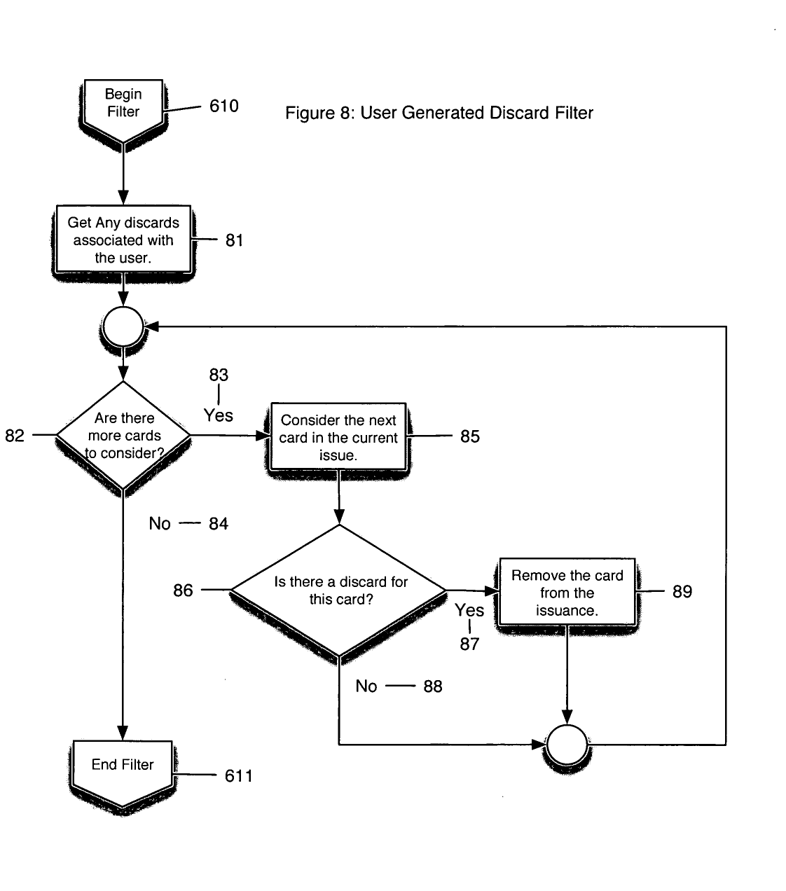

Diagram 7: FIG. 8 is a flowchart showing the operation of a filter that checks for user-generated “discards” that have been generated by user action.

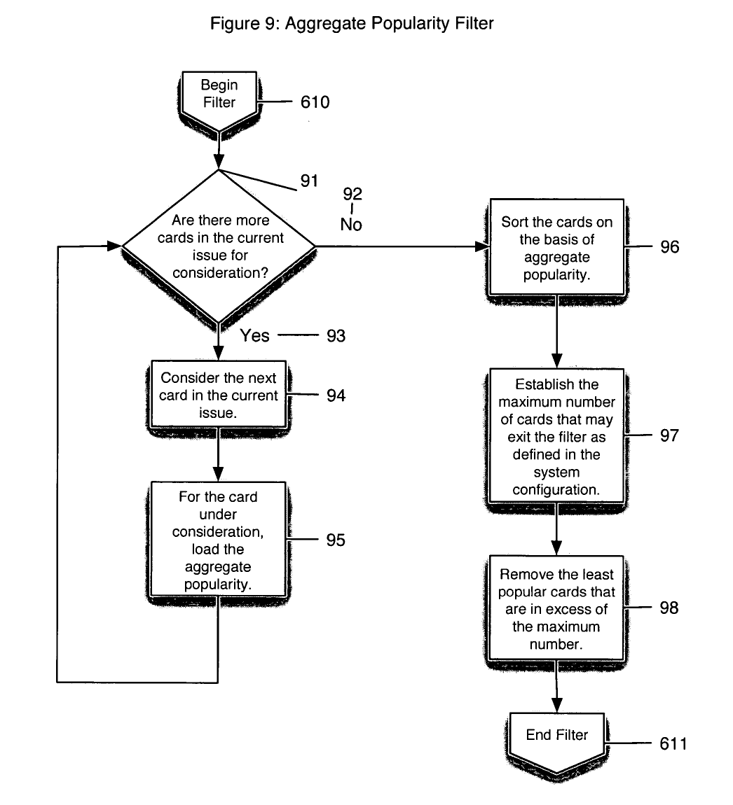

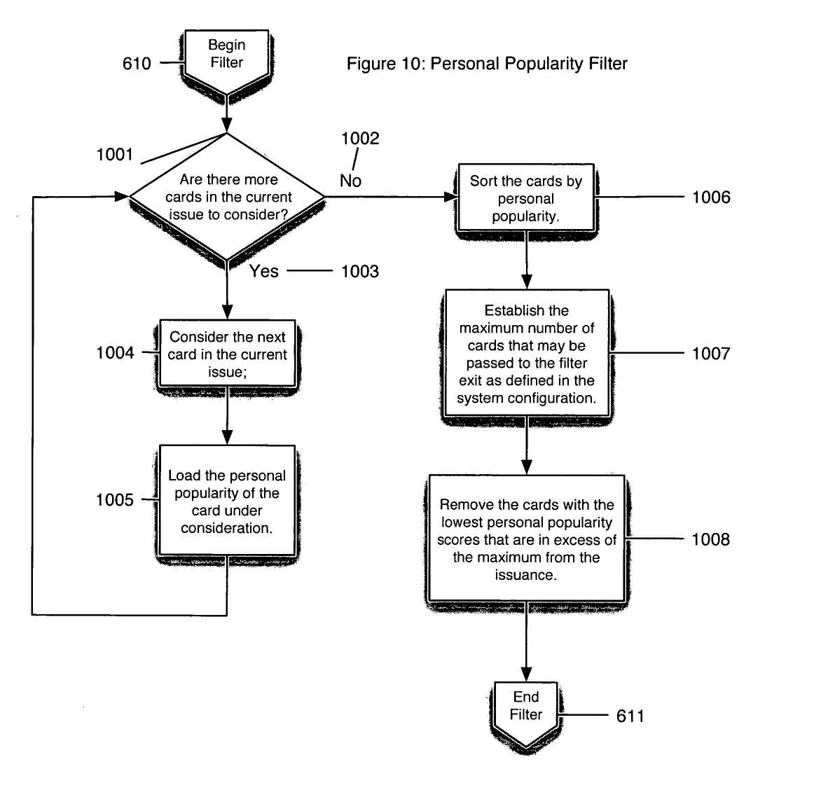

Diagram 8: FIG. 9 is a flowchart showing the operation of a filter that sorts cards by their overall, aggregate popularity and removes the least popular cards. Diagram 9: FIG. 10 is a flowchart showing the operation of a filter that sorts cards by their popularity with the active user (called “personal popularity”) and removes the least popular cards.

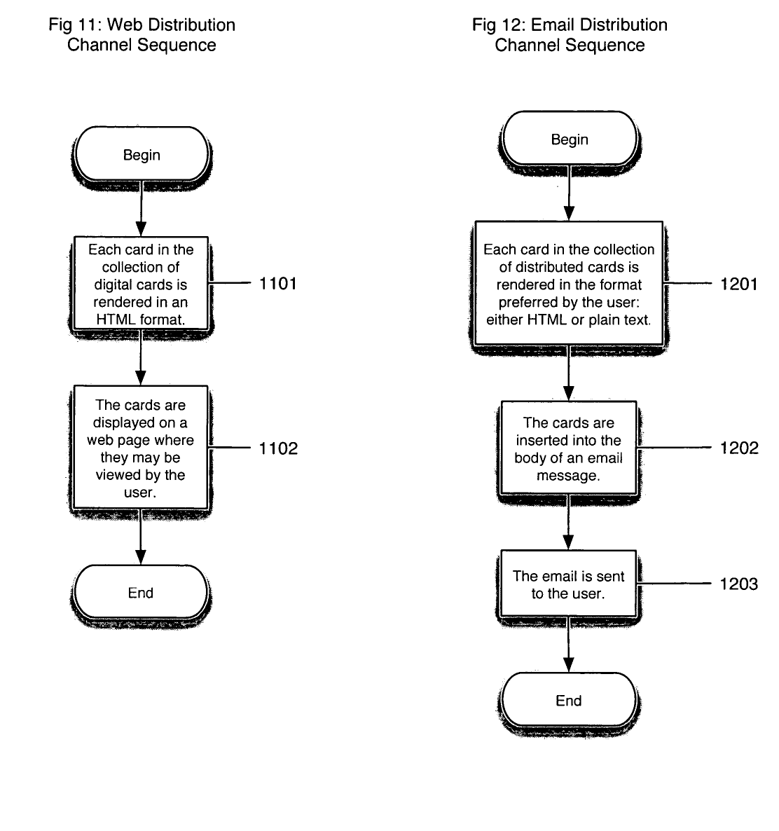

Diagram 10: This diagram details output channels: physical distribution media for the distribution engine. FIG. 11 is a flowchart showing the workflow of the web distribution channel. FIG. 12 is a flowchart showing the workflow of the email distribution channel.

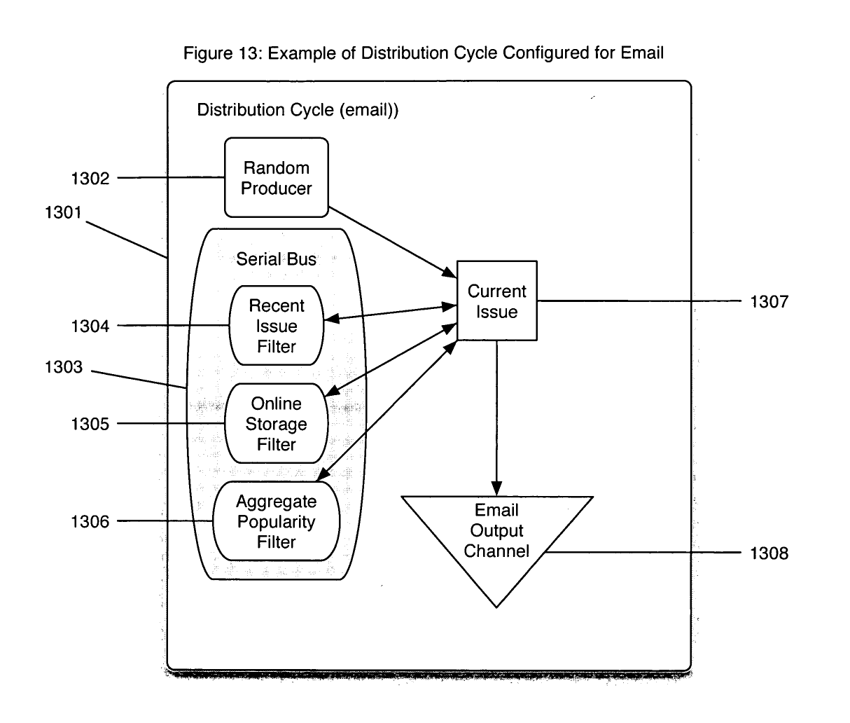

Diagram 11: FIG. 13 shows an example configuration of a distribution cycle, configured for an email output.

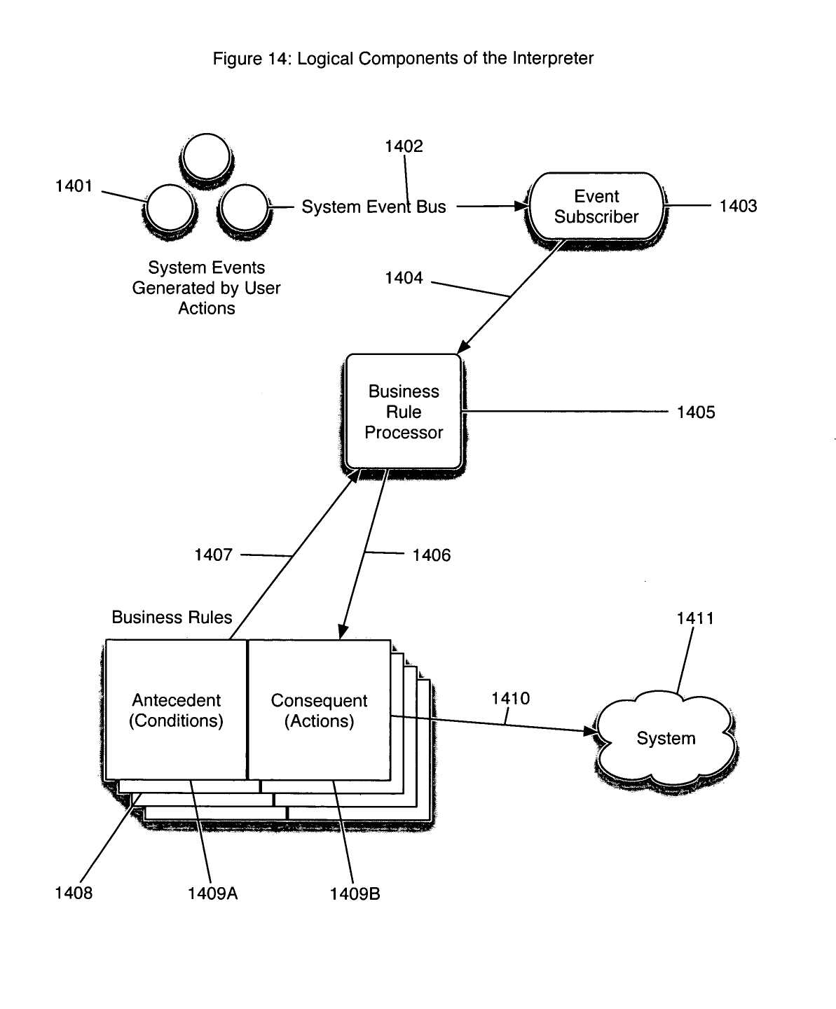

Diagram 12: FIG. 14 shows the logical components that comprise the Interpreter: the sub-system that translates user action into positive and negative statements regarding the popularity of content.

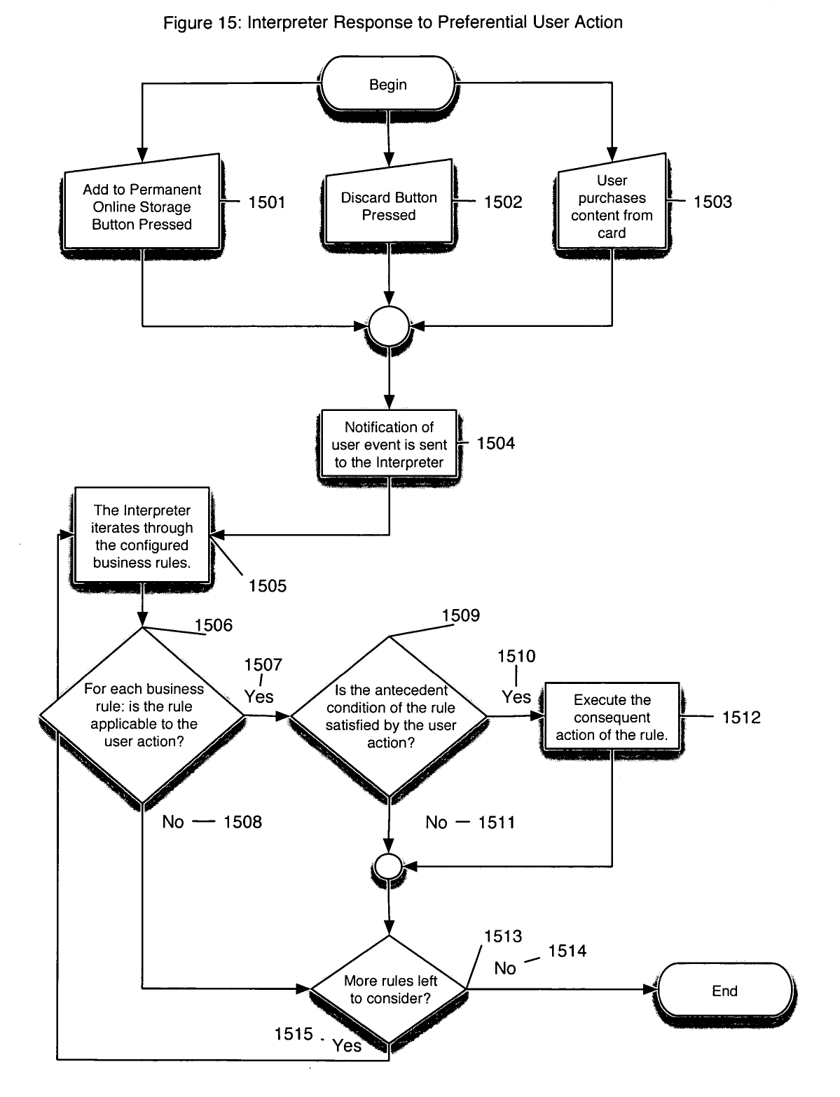

Diagram 13: FIG. 15 is a flowchart showing the operation of the interpreter system in its role of inferring user statements about content preferences through their interaction with the system.

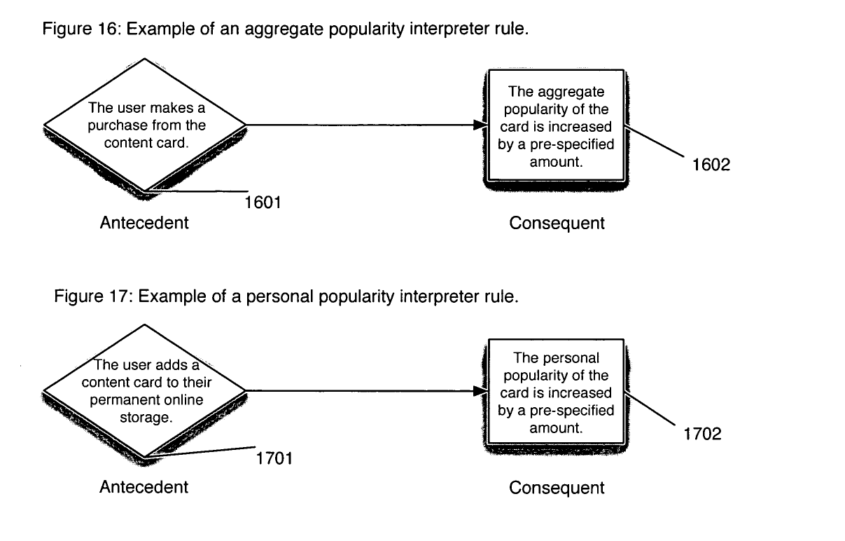

Diagram 14: This diagram details some example business rules used by the Interpreter as detailed in FIG. 15. FIG. 16 shows a business rule that modifies the aggregate popularity of a content card, and FIG. 17 shows a business rule that modifies the personal popularity of a content card. Both rules are shown with the antecedent side (the premises) leading to the consequent side (the conclusion or action).

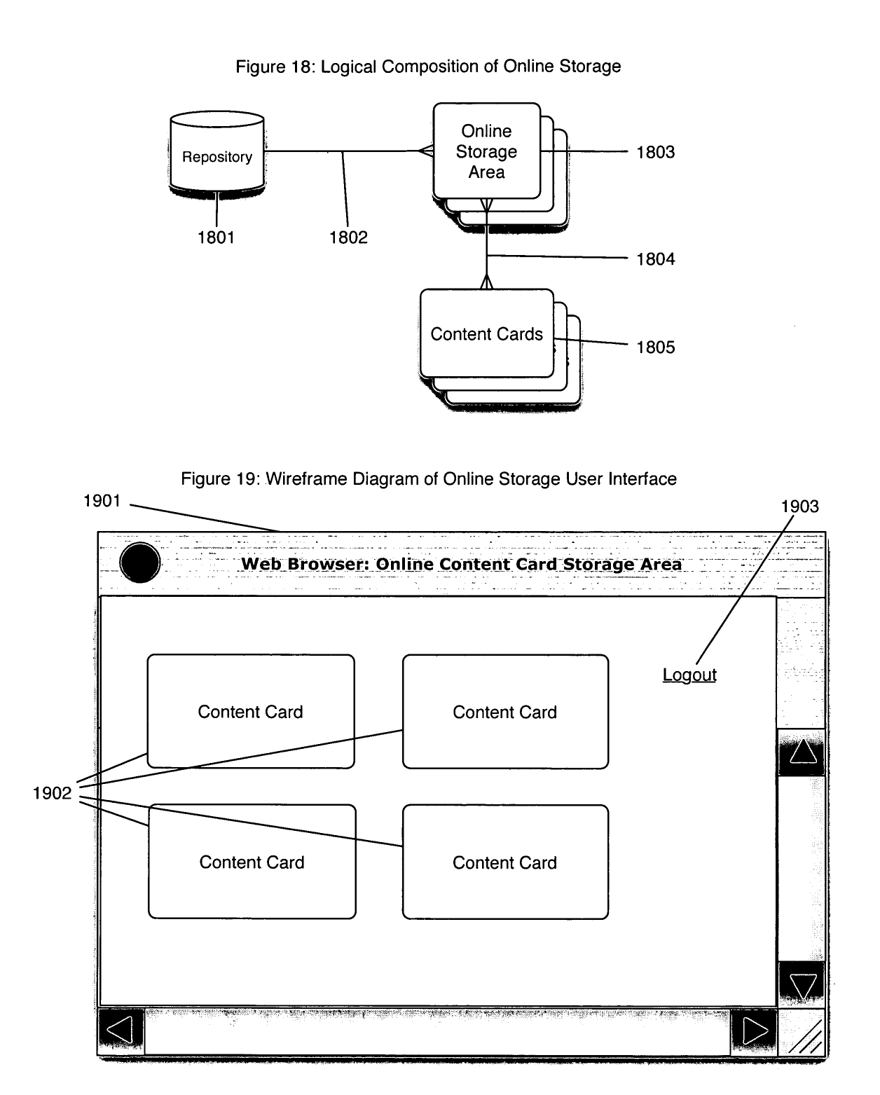

Diagram 15: FIG. 18 details the logical composition of the online storage facility: it shows the relationship of data that is stored on behalf of the user. FIG. 19 is a wire-frame diagram showing the general blocking of the user interface for the online storage area, as it would be implemented in one embodiment.

### DRAWING—REFERENCE NUMERALS

11 A control on the content card user interface that allows the content card to be associated with the user's permanent online storage area.
12 A control on the content card user interface that allows the user to indicate that they like the material presented by the card.
13 A control on the content card user interface that allows the user to indicate that they dislike the material presented by the card.
14 A control on the content card user interface that allows the user to “discard” the content card; creating a user generated filter (whose operation is detailed in FIG. 5) that prevents the card from being re-issued to the user again.
15 Area of the content card user interface that displays products for sale that are based on or inspired by content.
16 Area of the content card user interface that displays information about the subject of the content card.
17 A control on the content card user interface that allows the user to purchase products associated with the content card.
18 Area of the content card user interface that shows the topical name of the content card, such as, in one embodiment, the content creator or content theme.
21 A content card
22 The content (music, movies, prose, art etc.)
23 Commercial products for sale.
24 The aggregate popularity of the content card.
25 For each user, the personal popularity of the content card.
26 Records of explicit discards by users of the content card.
27 Records of recent issues of the content card to users.
31 A physical server computer on which the software comprising the invention is deployed.
32 The Internet or some other network (such as a local area network) over which the software communicates.
33 Personal computers on which users can interact with the software using web browsers such as Internet Explorer or Mozilla Firefox.
41 A central repository of content cards
42 A central repository of user preferences.
43 The process of card selection from the repository 41 by the distribution engine 46.
44 The action of the Interpreter 47 on content cards in the repository 41.
45 The action of the Interpreter 47 on user preferences 42.
46 The card distribution engine.
47 The user action interpreter.
48 A distribution cycle that uses the email distribution channel 413 as its output channel.
49 A distribution cycle that uses the web distribution channel 410 as its output channel.
410 The web distribution channel.
411 User actions on the user interface 417 being directed to the interpreter 47.
412 Users' online storage for content cards.
413 The email distribution channel.
414 Email being sent to users.
415 Results being sent to a web page.
416 Cards being sent to the users' online storage 412 through instructions given to the user interface 417.
417 The user interface of a content card.
418 An index of content card meta-data.
419 The distribution engine's reference to the meta-data index.
420 The index's reference to content cards in the repository.
51 A content card producer
52 Content filters
53 A content filter bus
54 The production of content cards by the producer 51 to create the current issue 57.
55 Interactions between filters 52 and the current issue 57.
56 A distribution cycle
57 The current issue: contains a set of content cards to be processed by the distribution cycle.
58 The current issue 57 being pushed to the output channel 59.
59 The output channel 59.
61 A test in which it is determined if their are user supplied search criteria.
62 A condition indicating there are user supplied search criteria.
63 A condition indicating there are no user supplied search criteria.
64 A process by which the user search terms are tokenized (broken into separate words or terms).
65 A process by which the user search tokens are compared against an index of tokenized metadata concerning content cards.
66 A process by which a random assortment of cards are pulled loaded from the repository.
67 A process by which cards indicated by the search index are loaded from the repository.
68 A process by which the raw cards (which constitute the current issue) are sent to the bus.
69 A process by which the current issue is sent to the next content filter.
610 The beginning of filter specific actions.
611 The end of filter specific actions.
612 A test in which it is determined if there are more filters in the bus.
613 A condition indicating that there are more filters in the bus.
614 A condition indicating that there are no more filters in the bus.
615 An output process in which the current issue is sent to the output channel.
71 A process by which a list of content cards that have recently been issued to the user are retrieved.
72 A process by which the next card in the current issue is brought under consideration.
73 A test in which it is determined if the card is listed on the list of recently issued cards.
74 A condition indicating that the card has been recently issued to the user.
75 A condition indicating that the card has not been recently issued to the user.
76 A process by which the card is removed from the current issue.
77 A test in which it is determined if there are more cards in the current issue to consider.
78 A condition indicating that there are no more cards in the current issue to consider.
79 A condition indicating that there are more cards in the current issue to consider.
81 A process by which any user generated filters that are associated with the current user are loaded from the repository.
82 A test in which it is determined if there are more cards to consider.
83 A condition indicating that there are more cards to consider.
84 A condition indicating that there are no more cards to consider.
85 A process in which the next card in the current issue is considered.
86 A test in which it is determined if there is a user generated filter for the current user for the card under consideration.
87 A condition indicating there is a matching user generated filter.
88 A condition indicating there is not a matching user generated filter.
89 A process by which the card under consideration is removed from the current issue.
91 A test in which it is determined if there are more cards for consideration in the current issue.
92 A condition indicating that there are no more cards in the current issue for consideration.
93 A condition indicating that there are more cards in the current issue for consideration.
94 A process by which the next card in the current issue is considered.
95 A process by which the aggregate popularity for the card under consideration is loaded into the filter.
96 A process by which the cards in the current issue are sorted on the basis of aggregate popularity (i.e. from most to least popular).
97 A process by which it is determined, from system configuration, what are the maximum number of cards that may exit the filter.
98 A process by which the least popular cards that exceed the maximum exit number (determined in 97) are removed from the current issue.
1001 A test in which it is determined if there are more cards in the current issue to consider.
1002 A condition indicating that there are no more cards in the current issue to consider.
1003 A condition indicating that there are more cards in the current issue to consider.
1004 A process by which the next card in the current issue is considered.
1005 A process by which the personal popularity for the card under consideration, for the current user, is loaded into the filter.
1006 A process by which the cards in the current issue are sorted on the basis of personal popularity.
1007 A process by which it is determined, from system configuration, what are the maximum number of cards that may exit the filter.
1008 A process by which the least popular cards that exceed the maximum exit number (determined in 1007) are removed from the current issue.
1101 A process by which each card in the current issue is rendered into an HTML format.
1102 A process by which the rendered cards are displayed on a web page, such as in the context of a web-based search result.
1201 A process by which each card in the current issue is rendered into the format indicated as the preferred format by the current user: either HTML or plain text.
1202 A process by which each rendered card is inserted into the body of an email message.
1203 A process by which the fully rendered email is sent to the user using standard SMTP transport technology.
1301 A distribution cycle, configured for email based card distribution 1302 A random content producer
1303 A serial bus
1304 A recent issue filter
1305 An online storage filter
1306 An aggregate popularity filter
1307 The current issue
1308 An email output channel
1401 Various events that are generated by user interaction with the user interface.
1402 Events are published on and travel over the event bus, where they are available to any subscriber system.
1403 The interpreter event subscriber.
1404 The event subscriber forwards events to the business rule processor.
1405 The business rule processor.
1406 The business rule processor executes rule consequents.
1407 The business rule processor evaluates rule antecedents.
1408 The business rule stack.
1409A The antecedent (condition) side of a business rule.
1409B The consequent (action) side of a business rule.
1410 Rule consequents take action upon the system, as defined in the business rule.
1411 The rest of the system.
1501 A user action in which the “Add to Permanent Online Storage” 11 button is pressed.
1502 A user action in which the “Discard” button 14 is pressed.
1503 A user action in which products are purchased from a content card.
1504 A process by which notification of the user action is sent as an event to the Interpreter.
1505 A process in which the interpreter iterates through the configured business rules.
1506 A test in which it is determined if the rule is applicable to the type of user action.
1507 A condition indicating that the rule under consideration is applicable to the type of user action.
1508 A condition indicating that the rule under consideration is not applicable to the type of user action.
1509 A test in which it is determined if the antecedent side of the rule under consideration is satisfied by the user action.
1510 A condition indicating the rule antecedent is satisfied by the user action.
1511 A condition indicating the rule antecedent is not satisfied by the user action.
1512 A process by which the consequent side of the rule is executed.
1513 A test in which it is determined if there are more business rules to consider.
1514 A condition indicating that there are no more business rules to consider.
1515 A condition indicating that there are more business rules to consider.
1601 A triggering antecedent condition in which the user makes a purchase from the content card.
1602 A consequent action in which the aggregate popularity of the card is increased by a pre-specified amount.
1701 A triggering antecedent condition in which the user adds a content card to their online storage.
1702 A consequent action in which the personal popularity of the card for that user is increased by a pre-specified amount.
1801 The main repository of online storage areas for users.
1802 The relationship between the repository and individual users' online storage areas (one repository to many storage areas).
1803 The online storage areas.
1804 The relationship between online storage areas and content cards (many-to-many).
1805 Individual content cards.
1901 A web browser window.
1902 Content cards rendered in HTML.
1903 A link to log out of the online storage area.

### DETAILED DESCRIPTION—PREFERRED EMBODIMENT—FIGS.

The invention is a computer program that locates and provides creative content to users that is relevant to their tastes and to general popularity. Content is displayed to the user through the metaphor of collectable cards, with each card representing a logical organization of content based on a natural unifying element, such as the content creator, a participant such as an actor or musician or some theme.

The user interacts with the system through the user interface detailed in FIG. 1. Resembling a collectable card and in one embodiment rendered in HTML, the card has an “Add to Permanent Online Storage Button” 11 which allows them to indicate to the system that they wish this content card to be added to their permanent online storage area. The “Positive Response Button” 12 allows them to indicate to the system that they approve of the content in the card. The “Negative Response Button” 13 allows them to indicate that they dislike the content in the card. The “Discard Button” 14 allows the user to create a filter preventing this card from ever being re-issued to them. The “Shop Button” 17 allows the user to purchase products that consist of or are associated with the content in the card.

A number of display areas exist on the user interface. The merchandise area 15 lists items that contain or are associated with the content on the card. They can be purchased by the user by pressing the “Shop Button” 17. The information area 16 contains a brief topical description of the subject of the card, such as biographical information about the content creator in one embodiment. The title area 18 contains the card title, which in one embodiment is the name of the content creator. The image area 19 contains a photograph of the content creator or some other topically relevant image.

The logical, data-oriented composition of a content card is detailed in FIG. 2. The organizational unit of the content card 21 is associated with a specific collection of creative content 22, with content oriented products 23, with a specific aggregate popularity 24 (expressible as a signed integer) and, for each user, a personal popularity 25 (also expressible as a signed integer).

The physical deployment of the program as it is in one embodiment, is detailed in FIG. 3. In one embodiment the program is hosted on a server 31 which is connected to the Internet or some other computer network 32. Via the network connection, it communicates with personal computers 33 which are used by individual users.

The user interface interacts with the general system, whose gross logical architecture is detailed in FIG. 4. All content cards are stored in the card repository 41. They are drawn via a selection process 43 into the distribution engine 46 where they are processed and distributed to the user via the web distribution channel 410 via its distribution cycle 49 or the email distribution channel 413 via its distribution cycle 48. The web distribution channel 410 renders the content cards as HTML and displays them via process 415 on a web page. The email distribution channel 413 renders the content cards either as HTML or plain text and emails them via process 414 to the user. Each rendered card presents a user interface 417 to the user.

Users pressing the “Add to Permanent Online Storage Button” 11 (see FIG. 1) on the user interface 417 will place the card in the permanent online storage area 412 by sending a command via process 416 to the system.

All user actions 411 are sent to the Interpreter 47 where they are evaluated for user preference information which is applied to the specific user's preferences 42 via process 45, or to the aggregate or personal popularity of the cards via process 44.

FIG. 5 details the logical composition of the distribution engine (part 46 on FIG. 4). The distribution engine contains a collection of pre-configured distribution cycles 56 with each cycle representing an overall distribution process under a specific scenario. Each distribution cycle contains a producer 51 which generates the raw selection of content cards that comprise the current issue 57, which is the object of each of the distribution cycle's processes. After the initial production of cards via process 54 the current issue 57 is sent to the filter bus 53 in which a collection of filters 52 evaluate and modify the current issue 57 via process 55. Finally the current issue 57 is pushed via process 58 to the cycle's configured output channel 59 which is responsible for delivering the current issue to the user.

FIG. 6 is a flowchart detailing the distribution process as executed by the distribution engine as it might be configured in one embodiment. First it is determined if their are user supplied search terms 61. If there are 62 then the search terms are tokenized 64, meaning that they are broken into individual words and phrases. The tokens are compared against an index of tokenized metadata concerning the content cards 65. Cards indicated by matches in the index are then loaded from the repository 67. Alternately, if there are no user supplied search terms 63 then a random assortment of cards is pulled from the repository 66.

The raw cards are sent to the main distribution bus, which contains a collection of content filters 68. Once in the bus, the cards in the current issue are sent to the next filter 69. FIG. 6 marks the beginning and end of the filter specific actions as parts 610 and 611, respectively. After filter actions it is determined if there are more filters to process 612. If there are 613 then control flow is passed back to part 69. If there are not 614 then the remaining cards are sent to the output channel 615.

FIG. 7 is a flowchart showing an example of content filter execution, in this case a filter that prevents cards that have been recently issued to a user to be issued again.

First the filter gets a list of cards that have been recently issued to the user 71. Then the filter considers the next card in the current issue 72. The filter determines if the card under consideration has been recently issued to the user, i.e. it is on the recent issue list 73. If it has been recently issued to the user 74 then the card is removed from the current issue 76. If it has not been recently issued to the user 75 then nothing happens.

Next the filter determines if there are more cards to consider 77. If there are 79 then flow control returns to part 72. If not 78 then the filter exits.

FIG. 8 shows the workflow of a discard filter: a filter that removes any cards that have been explicitly discarded by the user from the current issue. First the filter loads any discards associated with the user 81. Then it checks if there are more cards to consider in the current issue 82. If there are 83 then it considers the next card in the current issue 85. The filter checks if there is a discard for the card under consideration 86. If there is 87 then the card is removed from the current issue 89. If there is no discard 88 then no action is taken. If there are no more cards to consider 84 then the filter exits.

FIG. 9 shows the workflow for an aggregate popularity filter, a filter that ensures the cards with the highest aggregate popularity remain in the current issue and that the cards with the lowest aggregate popularity are removed. First the filter checks if there are more cards in the current issue to consider 91. If there are 93 then the next card in the current issue is considered 94. For the card under consideration, it's aggregate popularity is loaded into the filter 95.

If there are no more cards to be considered 92, then the filter sorts the cards on the basis of the loaded aggregate popularity 96. The filter then establishes the maximum number of cards that can exit the filter, as specified by system configuration 97. The filter removes the cards with the least aggregate popularity that are in excess of the maximum number of cards that may exit the filter 98 from the current issue. Then the filter exits.

FIG. 10 shows the workflow for a personal popularity filter, which is designed to keep the cards with the highest popularity with a specific user in the current issue, and to remove the cards with lowest popularity with a specific user (referred to as “personal popularity”). First the filter checks if there are more cards in the current issue to consider 1001. If there are 1003 then the next card in the current issue is considered 1004. The personal popularity for the card under consideration, for the current user is loaded into the filter 1005. If there are no more cards in the current issue to consider 1002 then the cards are sorted by the loaded personal popularity 1006. The filter establishes the maximum number of cards that may exit from the filter, as established in system configuration 1007. The filter removes the cards with the lowest personal popularity that are in excess of the maximum exit number from the current issue 1008.

FIG. 11 is a flowchart showing the workflow of the web distribution channel. First each card in the current issue is rendered in HTML format 1101. Then the rendered cards are displayed on a web page where they may be viewed by the user 1102.

FIG. 12 is a flowchart showing the workflow of the email distribution channel. First each card in the current issue is rendered in HTML or plain text format, depending on the preferences of the user 1201. Then the rendered cards are inserted into the body of a new email message 1202. Finally the channel sends the email to the user 1203.

FIG. 13 shows an example of a distribution cycle 1301 as it might be configured for an email output. In this example the random producer 1302 has been configured to produce a random raw collection of content cards contained by the current issue 1307. After production, the current issue will be sent to the bus, which is configured as a serial bus 1303. The serial bus 1303 has three filters configured which will be executed in order. The first is a recent issue filter 1304 which removes cards recently issued to the user from the current issue 1307. The second is an online storage filter 1305 which removes cards which the user has already placed in their online storage area. The third is an aggregate popularity filter 1306 which removes the cards with the lowest aggregate popularity from the current issue 1307. After all of the cards in the serial bus 1303 are executed, the current issue 1307 is pushed to the email output channel 1308 which renders the cards into an email and sends the email to the user.

FIG. 14 shows the logical components that comprise the Interpreter. Various events within the system generate events 1401 that contain information about the actions that caused them to be generated. These events are distributed throughout the system using the well-known paradigm of publish-subscribe messaging 1402. The Interpreter subscribes to the events via the event subscriber 1403. The event subscriber 1403 passes on relevant information from the events 1404. This information is received by the business rule processor 1405, which will evaluate at it against the business rule stack 1408. The rule processor 1405 will evaluate 1407 the antecedent side 1409A of each business rule. For each rule, if the antecedent side 1409A is satisfied, then the consequent side 1409B will be executed. The consequent side 1409B may contain any executable code which is then processed 1410 to modify properties of the rest of the system 1411.

FIG. 15 is a flowchart showing Interpreter response to user action as specified by a typical configuration in an embodiment. Interpreted user actions could include adding of a card to online storage 1501, the pressing of a discard button on a card 1502 or a user purchasing products from a content card 1503. In all cases notification of the event is sent to the interpreter 1504 via the messaging system. For each received event the interpreter iterates through the stack of business rules 1505. For each rule the interpreter determines if the rule is relevant to the event 1506. If it is 1507 then the interpreter determines if the rule's antecedent condition is satisfied by the user action 1509. If it is 1510 then the interpreter executes the consequent action of the rule 1512. After processing the action, or if the rule was not relevant 1508 or if the antecedent condition was not satisfied 1511 then the next rule is the stack is considered 1513. If there are more rules to consider 1515 then control is returned to process 1505. If there are no more rules to consider 1514 then the interpreter process exits.

FIG. 16 is an example of an interpreter rule that would be used to modify the aggregate popularity of a content card. The antecedent condition of this rule 1601 is that a user make a purchase from the content card. If the condition is satisfied then the consequent action 1602 is to increase the aggregate popularity of the content card by a pre-specified amount.

FIG. 17 is another example of an interpreter rule. This one modifies the personal popularity of a content card. The antecedent condition 1701 is that the user adds the content card to their online storage area. If they do the the consequent action 1702 will be executed: the personal popularity of the card will be increased, for that user, by a pre-specified amount.

FIG. 18 is the logical composition of the online storage repository. It consists of the main repository 1801 which contains many online storage areas 1803. There is a one-to-many relationship 1802 between the repository and the online storage areas, respectively. Each online storage area contains a number of content cards 1805. There is a many-to-many relationship 1804 between the content cards and the online storage areas, since each area may contain many cards, and each card may be placed in many storage areas (by different users).

FIG. 19 is a wire-frame diagram of the online storage area user interface. The interface, in one embodiment, is viewed through a web browser 1901. It contains several content cards 1902 that have been added there by the user. In one embodiment, access to the area must be authenticated, so the diagram shows a link to log out 1903 (de-authenticate) of the area.

### OPERATION—PREFERRED EMBODIMENT—FIGS.

Content Sampling

The invention provides a medium for a user to become familiar with content and then to purchase products that are relevant to it (often including bundles of the content itself). A content card (user interface detailed in FIG. 1) will provide imagery 19 and background information 16 on its subject, and then provide samples of the relevant content 15 for the user to try free of charge which, in one embodiment, are available as downloadable files. If the user wishes they may then purchase content related products from the card, using well-known e-commerce practices.

Content Distribution

Content distribution is initialized by one of several contextual scenarios. In one embodiment, a user may perform a web search from a standard HTML web form, entering search terms that are to be submitted to the distribution engine 46. In another embodiment, a periodic automated mass email may initiate a distribution in order to populate an email to be sent to a user. In each case, an appropriate distribution cycle 56 will be selected within the main distribution engine 46 that is configured to meet the needs of the distribution scenario.

(Distribution workflow is also represented in FIG. 6.)

Within the selected distribution cycle 56 the producer 51 will determine if there are user search criteria. If there are, the search terms are tokenized (broken into individual terms) and compared against an index 418 that references the stored content card repository 41. Cards indicated by matching terms in the index 418 are then pulled from the repository 41. If there are no search terms then a random assortment of cards is pulled from the repository 41. In both cases, the retrieved cards represent the current issue 57, which is the subject of all subsequent operations within the distribution cycle 56.

The current issue 57 is pushed to the main bus 53 which contains a pre-configured array of filters 52. Each filter performs specific actions on the current issue 57, filtering out the least appropriate cards based on its specific criteria.

A recent issue filter (workflow portrayed on FIG. 7) will get a list of content cards recently issued to the current user by referencing content cards by their recent issue information 27. It will remove all cards on this list from the current issue 57, thus ensuring that the user is not issued a card that they have already recently been issued.

Popularity filters such as an aggregate popularity filter (workflow portrayed in FIG. 9) will sort the cards according to their aggregate popularity 24. The popularity filters will remove a pre-configured number of the lowest ranking cards from the current issue 57.

Use of filters is configurable and optional for any distribution cycles. Examples of distribution filter workflow are examined in depth in the diagrams, but it is possible that additional filters may be added a distribution cycle, and it is possible that not all filters would be used in any given configured distribution cycle.

Once each filter 52 in the main distribution bus 53 has taken its specific actions on the current issue 57, the current issue 57 is pushed to the output channel 59. The output channel is responsible for physically rendering the cards' user interface (detailed in FIG. 1) and distributing the rendered cards to the user.

The specific actions of the output channel are distribution cycle specific. In one embodiment, a web search output channel (detailed in FIG. 11) renders each remaining content card in the current issue 57 into HTML format and then displays it on a “search results” web page where it may be viewed by the user. In one embodiment, an email distribution channel (detailed in FIG. 12) renders each card in either HTML or plain text format, based on user preferences, and then inserts the body of the rendered content cards into an email. The email is then sent to the user.

Interpretation

Besides content distribution, the system is concerned with the interpretation of user behavior for the purpose of modifying the popularity of content cards in order to provide higher quality distribution results. To this end the interpreter system (detailed in FIG. 14) works to convert user events 1401 into consequent actions that modify the system in meaningful ways. Triggering user events 1401 include the purchase of a product from a content card, the addition of a card to a user's online storage area, a user pressing the “discard” button on a content card and possibly other event triggering actions. Each event is broadcast on the system event bus 1402, which is implemented using the well-known paradigm of publish-subscribe messaging. The event subscriber 1403 listens to the system event bus and passes events to the business rule processor 1405. The business rule processor extracts the relevant information concerning the event and compares it to the antecedent side of each rule 1409A in the business rule stack 1408.

If the antecedent side of a business rule 1409A is both relevant and satisfied by the information in the event, then the business rule processor 1405 fires the consequent side of the business rule 1409B, executing whatever action is proscribed there. Generally most business rules will proscribe the modification of either the personal popularity 25 or aggregate popularity 24 of a content card in either a positive or negative manner.

### CONCLUSION, RAMIFICATIONS, AND SCOPE

Accordingly the reader will see that, the invention provides a means for the user to sample and become familiar with content that is most likely to be of interest to them. This provides content consumers with an easier way to locate content that is of interest to them, and an easier way for content creators or providers to reach the appropriate audience for their content.

While the above description contains many specificities, these should not be construed as limitations on the scope of the invention, but as exemplifications of the presently preferred embodiments thereof. Many other ramifications and variations are possible within the teachings of the invention. For example, content cards may be distributed through other media or in other formats, such as to a cell phone via the WAP protocol, or to a dedicated client application program. The invention could be used to organize content for research purposes: adaptively modifying popularity of cards in relation to their relevance to a vector of research, perhaps as implemented by an automated search program.

Accordingly the scope of the invention should be determined not by the embodiment illustrated but by the appended claims and their legal equivalents.

1. A method for organizing and marketing of creative content over an online medium, comprising:
a) Providing a user interface rendered on a display, showing representations of collectable cards with each card signifying a thematic aggregation of content,
b) Providing a memory that contains data comprising the digital representation of said content and associated meta-data that comprise said content cards,
c) Providing a memory that contains pointers to said content cards and associates them with a value that represents the popularity of said content cards,
d) Providing a memory controller which will interpret user behavior and consequently modify said popularity of content cards,
whereby said display will show said content cards that are matched to the individual tastes of a human operator, and are generally popular.

2. The provision of said memory containing said content cards of claim 1 further including the provision of a memory that contains persistent associations between said content cards and said operator whereby said associated cards may be retrieved for review by said operator.

3. The provision of said user interface of claim 1 wherein said user interface is rendered in a web browser.

4. The provision of said user interface of claim 1 wherein said user interface is rendered in a cellular telephone display.

5. The provision of said user interface of claim 1 wherein said user interface is rendered in a desktop computer application.

6. The provision of said user interface of claim 1 wherein said user interface is rendered in personal digital assistant device.

7. The provision of said user interface of claim 1 wherein said user interface is rendered in Rich Site Summary (RSS) format.

8. A machine for organizing and marketing of creative content over an online medium, comprising:
a) A user interface rendered on a display, showing representations of collectable cards with each card signifying a thematic aggregation of content,
b) A memory that contains data comprising the digital representation of said content and associated meta-data that comprise said content cards,
c) A memory that contains pointers to said content cards and associates them with a value that represents the popularity of said content cards,
d) A memory controller which will interpret user behavior and consequently modify said popularity of content cards,
whereby said display will show said content cards that are matched to the individual tastes of a human operator, and are generally popular.

9. The memory containing said content cards of claim 8 further including a memory that contains persistent associations between said content cards and said operator whereby said associated cards may be retrieved for review by said operator.

10. The user interface of claim 8 wherein said user interface is rendered in a web browser.

11. The user interface of claim 8 wherein said user interface is rendered in a cellular telephone display.

12. The user interface of claim 8 wherein said user interface is rendered in a desktop computer application.

13. The user interface of claim 8 wherein said user interface is rendered in a personal digital assistant device.

14. The user interface of claim 8 wherein said user interface is rendered in a Rich Site Summary (RSS) format.
